(19) United States
(12) Patent Application Publication
(10) Pub. No.: US 2026/0166546 A1
(43) Pub. Date: Jun. 18, 2026

(54) DEVICE AND METHODS FOR ISOLATING MICROORGANISMS FROM BIOLOGICAL SAMPLES FOR DIAGNOSTIC ANALYSIS

(71) Applicant: Siemens Healthcare Diagnostics Inc., Tarrytown, NY (US)

(72) Inventor: David Ledden, Elkhart, IN (US)

(73) Assignee: Siemens Healthcare Diagnostics Inc., Tarrytown, NY (US)

(21) Appl. No.: 19/126,769

(22) PCT Filed: Nov. 1, 2023
(86) PCT No.: PCT/US2023/078305

§ 371 Date: May 2, 2025

Related U.S. Application Data
(60) Provisional application No. 63/382,780, filed on Nov. 8, 2022.

(51) Int. Cl. B01L 3/00; B01D 61/18

(52) U.S. Cl. CPC B01L 3/50273; B01D 61/18; B01L 3/5027; B01L 3/502715; B01L 3/502738; B01L 3/502753; B01L 2200/027; B01L 2300/0816

(57) ABSTRACT

A method of isolating microorganisms present in a biological sample for diagnostic analysis, such as a diagnostic assay for sepsis. The method involves the use of filtration and acoustophoresis to substantially lyse any blood cells present in the biological sample and isolate any microorganisms present in the biological sample from the lysed cellular debris. Also disclosed are microfluidic devices, kits, and systems that can be utilized in the method.

### CROSS REFERENCE TO RELATED APPLICATIONS/INCORPORATION BY REFERENCE STATEMENT

This application claims benefit under 35 USC § 119(e) of U.S. Provisional Application No. 63/382,780, filed Nov. 8, 2022. The entire contents of the above-referenced patent application are hereby expressly incorporated herein by reference.

### STATEMENT REGARDING FEDERALLY SPONSORED RESEARCH OR DEVELOPMENT

Not Applicable.

### BACKGROUND

Sepsis is a potentially life-threatening condition that arises when the body's response to an infection injures its own tissues and organs; sepsis has been referred to as “one of the oldest and most elusive syndromes in medicine.” Despite advances in care, existing epidemiologic studies suggest that sepsis remains a huge burden across all economic regions. In the United States, admissions for sepsis have overtaken those for myocardial infarction and stroke. Sepsis continues to be the major infection-related cause of death globally and is the tenth leading cause of death in the United States, with an incidence rate of up to 535 cases per 100,000 person-years and rising. In-hospital mortality remains high at 25-30%. Fleischmann et al. (2016) Am J Respir Crit Care Med., 193(3):259-72; and Angus, et al. (2001) Crit Care Med. 29(7):1303-10.

Prompt recognition of the septic patient and early identification of the organism causing the infection are critical. However, despite advances in modern medicine including new antibiotics and vaccines, early recognition and best practice treatments, as well as efficient, well-equipped intensive care units, the high rate of mortality associated with sepsis has changed little for decades (Daniels, R. (2011) J Antimicrobial Chemotherapy, 66(Suppl 2): ii11-ii23).

Therefore, there is a continued need in the art for new and improved diagnostic methods that overcome the disadvantages and defects in the prior art and provide early diagnosis of sepsis as well as early identification of the infectious organism involved.

### DETAILED DESCRIPTION

Before explaining at least one embodiment of the present disclosure in detail by way of exemplary language and results, it is to be understood that the present disclosure is not limited in its application to the details of construction and the arrangement of the components set forth in the following description. The present disclosure is capable of other embodiments or of being practiced or carried out in various ways. As such, the language used herein is intended to be given the broadest possible scope and meaning; and the embodiments are meant to be exemplary—not exhaustive. Also, it is to be understood that the phraseology and terminology employed herein is for the purpose of description and should not be regarded as limiting.

Unless otherwise defined herein, scientific and technical terms used in connection with the present disclosure shall have the meanings that are commonly understood by those of ordinary skill in the art. Further, unless otherwise required by context, singular terms shall include pluralities and plural terms shall include the singular. The foregoing techniques and procedures are generally performed according to conventional methods well known in the art and as described in various general and more specific references that are cited and discussed throughout the present specification. The nomenclatures utilized in connection with, and the medical procedures and techniques of, surgery, anesthesia, wound healing, and infectious control described herein are those well-known and commonly used in the art. Standard techniques are used for infection diagnostic and therapeutic applications.

All patents, published patent applications, and non-patent publications mentioned in the specification are indicative of the level of skill of those skilled in the art to which the present disclosure pertains. All patents, published patent applications, and non-patent publications referenced in any portion of this application are herein expressly incorporated by reference in their entirety to the same extent as if each individual patent or publication was specifically and individually indicated to be incorporated by reference.

All of the compositions, kits, and/or methods disclosed herein can be made and executed without undue experimentation in light of the present disclosure. While the compositions, kits, and/or methods have been described in terms of particular embodiments, it will be apparent to those of skill in the art that variations may be applied to the compositions, kits, and/or methods and in the steps or in the sequence of steps of the methods described herein without departing from the concept, spirit, and scope of the present disclosure. All such similar substitutions and modifications apparent to those skilled in the art are deemed to be within the spirit, scope, and concept of the present disclosure as defined by the appended claims.

As utilized in accordance with the present disclosure, the following terms, unless otherwise indicated, shall be understood to have the following meanings:

The use of the term “a” or “an” when used in conjunction with the term “comprising” in the claims and/or the specification may mean “one,” but it is also consistent with the meaning of “one or more,” “at least one,” and “one or more than one.” As such, the terms “a,” “an,” and “the” include plural referents unless the context clearly indicates otherwise. Thus, for example, reference to “a compound” may refer to one or more compounds, two or more compounds, three or more compounds, four or more compounds, or greater numbers of compounds. The term “plurality” refers to “two or more.”

The use of the term “at least one” will be understood to include one as well as any quantity more than one, including but not limited to, 2, 3, 4, 5, 10, 15, 20, 30, 40, 50, 100, etc. The term “at least one” may extend up to 100 or 1000 or more, depending on the term to which it is attached; in addition, the quantities of 100/1000 are not to be considered limiting, as higher limits may also produce satisfactory results. In addition, the use of the term “at least one of X, Y, and Z” will be understood to include X alone, Y alone, and Z alone, as well as any combination of X, Y, and Z.

The use of ordinal number terminology (i.e., “first,” “second,” “third,” “fourth,” etc.) is solely for the purpose of differentiating between two or more items and, unless explicitly stated otherwise, is not meant to imply any sequence or order or importance to one item over another or any order of addition, for example.

The use of the term “or” in the claims is used to mean an inclusive “and/or” unless explicitly indicated to refer to alternatives only or unless the alternatives are mutually exclusive. For example, a condition “A or B” is satisfied by any of the following: A is true (or present) and B is false (or not present), A is false (or not present) and B is true (or present), and both A and B are true (or present).

As used herein, any reference to “one embodiment,” “an embodiment,” “some embodiments,” “one example,” “for example,” or “an example” means that a particular element, feature, structure, or characteristic described in connection with the embodiment is included in at least one embodiment. The appearance of the phrase “in some embodiments” or “one example” in various places in the specification is not necessarily all referring to the same embodiment, for example. Further, all references to one or more embodiments or examples are to be construed as non-limiting to the claims.

Throughout this application, the term “about” is used to indicate that a value includes the inherent variation of error for a composition/apparatus/device, the method being employed to determine the value, or the variation that exists among the study subjects. For example, but not by way of limitation, when the term “about” is utilized, the designated value may vary by plus or minus twenty percent, or fifteen percent, or twelve percent, or eleven percent, or ten percent, or nine percent, or eight percent, or seven percent, or six percent, or five percent, or four percent, or three percent, or two percent, or one percent from the specified value, as such variations are appropriate to perform the disclosed methods and as understood by persons having ordinary skill in the art.

As used in this specification and claim(s), the words “comprising” (and any form of comprising, such as “comprise” and “comprises”), “having” (and any form of having, such as “have” and “has”), “including” (and any form of including, such as “includes” and “include”), or “containing” (and any form of containing, such as “contains” and “contain”) are inclusive or open-ended and do not exclude additional, unrecited elements or method steps. For example, a process, method, article, or apparatus that comprises a list of elements is not necessarily limited to only those elements but may include other elements not expressly listed or inherently present therein.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AAB, BBC, AAABCCCC, CBBAAA, CABABB, and so forth. The skilled artisan will understand that typically there is no limit on the number of items or terms in any combination, unless otherwise apparent from the context.

As used herein, the term “substantially” means that the subsequently described event or circumstance completely occurs or that the subsequently described event or circumstance occurs to a great extent or degree. For example, when associated with a particular event or circumstance, the term “substantially” means that the subsequently described event or circumstance occurs at least 80% of the time, or at least 85% of the time, or at least 90% of the time, or at least 95% of the time. The term “substantially adjacent” may mean that two items are 100% adjacent to one another, or that the two items are within close proximity to one another but not 100% adjacent to one another, or that a portion of one of the two items is not 100% adjacent to the other item but is within close proximity to the other item.

The term “sample” as used herein will be understood to include any type of biological sample that may be utilized in accordance with the present disclosure. In certain embodiments, the sample may be any fluidic sample and/or sample capable of being fluidic (e.g., a biological sample mixed with a fluidic substrate). Examples of biological samples that may be utilized include, but are not limited to, whole blood or any portion thereof (i.e., plasma or serum), saliva, sputum, cerebrospinal fluid (CSF), surgical drain fluid, skin, intestinal fluid, intraperitoneal fluid, cystic fluid, sweat, interstitial fluid, extracellular fluid, tears, mucus, bladder wash, urine, swabs, semen, fecal, pleural fluid, nasopharyngeal fluid, combinations thereof, and the like. In particular (but non-limiting) examples, the biological sample may be urine, stool, sexually transmitted infection (STI) swabs, respiratory collections, and the like.

The term “microorganism” as used herein will be understood to include any type of microorganism known in the art, including (but not limited to) Gram-negative and Gram-positive bacteria, viruses, yeasts, fungi, molds, and the like.

The term “Gram-positive bacteria” as used herein will be understood to include (by way of example only and not by way of limitation) bacteria of the following genera: Bacillus; Bifidobacterium; Clostridium; Corynebacteria; Deinococcus; Enterococcus (such as, but not limited to, vancomycin-resistant Enterococcus species); Lactobacillus; Listeria (such as, but not limited to, L. monocytogenes); Micrococcus; Mycobacteria; Nocardia; Staphylococcus (such as, but not limited to, S. aureus and methicillin-resistant S. aureus (MRSA)); Streptococcus (such as, but not limited to, Group A and Group B Streptococcus, and in particular, S. agalactiae, S. pneumoniae, and S. pyogenes); and the like.

The term “Gram-negative bacteria” as used herein will be understood to include (by way of example and not by way of limitation) bacteria of the following genera: Bacteroides (such as, but not limited to, B. fragilis); Campylobacter; Chlamydia (such as, but not limited to, C. pneumoniae); Eikenella (such as, but not limited to, E. corrodens); Enterobacter; Escherichia (such as, but not limited to, E. coli); Haemophilus (such as, but not limited to, H. influenzae); Klebsiella (such as, but not limited to, K. pneumoniae); Neisseria (such as, but not limited to, N. meningitidis); Proteus; Pseudomonas (such as, but not limited to, P. aeruginosa); Salmonella; Serratia; and the like.

The term “fungus” as used herein will be understood to include both yeasts and molds. Non-limiting examples of fungi include Aspergillus, Candida, Cladosporium, Cryptococcus, Histoplasma, Penicillium, Pneumocystis, Saccharomyces, and Trichosporon.

The term “acoustophoresis” as used herein will be understood to refer to the application of an ultrasonic acoustic standing waves at a resonant frequency sufficient to rupture cell walls of blood cells and lyse the blood cells. For example, but not by way of limitation, an acoustic transducer may be utilized to emit ultrasonic acoustic waves at one or more frequencies in a range of from about 320 kHz to about 350 kHz.

The present disclosure is directed to novel methods of diagnosing sepsis that provide for a rapid sepsis diagnosis that is achieved in much less time than currently available sepsis diagnostic methods. The methods of the present disclosure involve the rapid destruction of blood cells in a biological sample without destruction of microorganisms present in the biological sample; this result is achieved through the use of acoustophoresis, which can be performed in a fraction of the amount of time required by other separation techniques currently used in sepsis diagnostic assays. The decreased turnaround times associated with the methods of the present disclosure provides a distinct advantage over prior art methods and will have a definite and direct impact on sepsis outcomes.

Certain non-limiting embodiments of the present disclosure are directed to methods of isolating intact microorganisms present in a biological sample for diagnostic analysis, such as (but not limited to) for sepsis diagnosis. In the method, a biological sample is diluted to provide a mixture, and the mixture is pre-filtered to remove debris by passage through a first filter membrane (thereby producing a pre-filtered mixture). The pre-filtered mixture is then exposed to acoustophoresis at a frequency sufficient to lyse substantially all blood cells present in the mixture, and the acoustophoresis-treated mixture is filtered to remove debris resulting from the blood cell lysis by passing the acoustophoresis-treated mixture through a second filter membrane; in this manner, any microorganisms present in the biological sample are isolated in an intact/viable form on the second filter membrane.

The methods of the present disclosure may include one or more additional steps that allow for detection and/or identification of microorganism(s) isolated via the methods described herein above. These steps typically include a diagnostic assay, such as (but not limited to) a sepsis assay. These one or more additional steps may be performed directly on the second filter membrane; alternatively (and/or in addition thereto), the second filter membrane may be contacted with one or more reagents for removal of any microorganisms therefrom, and then the microorganism-containing reagent(s) may be subjected to one or more additional assay steps.

For example (but not by way of limitation), the method may further include the step of performing (after the filtration step) at least one diagnostic assay on the second filter membrane to identify a genus of microorganism present on the second filter membrane.

In another non-limiting example, the method may further include the steps of incubating an upper surface of the second filter membrane with an aqueous reagent such that any microorganism isolated on the second filter membrane is suspended in the aqueous reagent and then performing at least one diagnostic assay on the aqueous reagent to identify a genus of microorganism suspended therein.

Diagnostic assays that may be utilized in accordance with the present disclosure, including (but not limited to) sepsis assays, are well known in the art, and the selection of diagnostic assays that can be utilized following the microorganism isolation methods described herein are within the full purview of a person having ordinary skill in the art. Therefore, no further description of such assays is deemed necessary.

The biological sample may be diluted in any buffer and to any concentration that allows the biological sample to subsequently be subjected to the treatment steps described herein for the isolation of microorganisms present therein. For example, but not by way of limitation, the biological sample may be diluted in a buffer selected from the group consisting of any sodium chloride-containing, isotonic buffer; phosphate buffered saline; Bis-Tris; Bis-Tris propane; ADA (N-(2-Acetamido)iminodiacetic acid); PIPES (Piperazine-N,N′-bis(2-ethanesulfonic acid); ACES (N-2-aminoethanesulfonic acid); MOPS (3-morpholinopropanesulfonic acid), MOPSO (3-Morpholino-2-hydroxypropanesulfonic acid); BES (N,N-bis[2-hydroxyethyl]-2-aminoethanesulfonic acid); TES (2-[[1,3-dihydroxy-2-(hydroxymethyl) propan-2-yl]amino]ethanesulfonic acid); HEPES (4-(2-hydroxyethyl)-1-piperazineethanesulfonic acid); DIPSO (3-(N,N-Bis[2-hydroxyethyl]amino)-2-hydroxypropanesulfonic acid; N,N-Bis(2-hydroxyethyl)-3-amino-2-hydroxypropanesulfonic acid); and TRIZMA® buffers (Sigma-Aldrich, St. Louis, MO); combinations thereof; and the like. Also, the biological sample may be diluted, for example (but not by way of limitation), at least about 2-fold, about 3-fold, about 4-fold, about 5-fold, about 6-fold, about 7-fold, about 8-fold, about 9-fold, about 10-fold, about 20-fold, about 30-fold, about 40-fold, about 50-fold, about 60-fold, about 70-fold, about 80-fold, about 90-fold, about 100-fold, about 110-fold, about 120-fold, about 125-fold, about 130-fold, about 140-fold, about 150-fold, about 160-fold, about 170-fold, about 175-fold, about 180-fold, about 190-fold, about 200-fold, about 225-fold, about 250-fold, about 275-fold, about 300-fold, about 325-fold, about 350-fold, about 375-fold, about 400-fold, about 425-fold, about 450-fold, about 475-fold, about 500-fold, about 550-fold, about 600-fold, about 650-fold, about 700-fold, about 750-fold, about 800-fold, about 850-fold, about 900-fold, about 950-fold, about 1,000-fold, about 1,100-fold, about 1,200-fold, about 1,300-fold, about 1,400-fold, about 1,500-fold, about 1,600-fold, about 1,700-fold, about 1,800-fold, about 1,900-fold, about 2,000-fold, about 2,100-fold, about 2,200-fold, about 2,300-fold, about 2,400-fold, about 2,500-fold, about 2,600-fold, about 2,700-fold, about 2,800-fold, about 2,900-fold, about 3,000-fold, about 3,100-fold, about 3,200-fold, about 3,300-fold, about 3,400-fold, about 3,500-fold, about 3,600-fold, about 3,700-fold, about 3,800-fold, about 3,900-fold, about 4,000-fold, about 4,100-fold, about 4,200-fold, about 4,300-fold, about 4,400-fold, about 4,500-fold, about 4,600-fold, about 4,700-fold, about 4,800-fold, about 4,900-fold, about 5,000-fold, about 5,500-fold, about 6,000-fold, about 6,500-fold, about 7,000-fold, about 7,500-fold, about 8,000-fold, about 8,500-fold, about 9,000-fold, about 9,500-fold, about 10,000-fold, or more. In addition, the biological sample may be diluted between a range of any two of the above values (i.e., a range of from about 2-fold to about 5,000-fold, a range of from about 10-fold to about 1,000-fold, etc.), and may be diluted by a value that is an integer that falls between any two of the above values.

The types and sizes of the first and second filter membranes can vary widely, so long as the first and second filter membranes are capable of functioning in accordance with the present disclosure. In particular, (1) the first filter membrane must have a larger pore size than the second filter membrane; (2) the first filter membrane must have a pore size that is larger than a microorganism to be tested and through which microorganisms will pass; and (3) the second filter membrane must have a pore size that is smaller than microorganisms to be tested (i.e., smaller than the length and/or width of a bacterial cell or a fungus).

In certain non-limiting embodiments, the first filter membrane is formed of a material such as (for example, but not by way of limitation) cellulose (such as, but not limited to, cellulose acetate and cellulose nitrate), glass fiber, nylon, polyester, polytetrafluoroethylene (PTFE), polyethersulfone (PES), silicon, any combinations thereof, and the like. In certain non-limiting embodiments, the first filter membrane has a pore size of at least about 1 micron, about 2 micron, about 3 micron, about 4 micron, about 5 micron, about 6 micron, about 7 micron, about 8 micron, about 9 micron, about 10 micron, about 11 micron, about 12 micron, about 13 micron, about 14 micron, about 15 micron, about 16 micron, about 17 micron, about 18 micron, about 19 micron, about 20 micron, about 25 micron, about 30 micron, about 35 micron, about 40 micron, about 45 micron, about 50 micron, about 55 micron, about 60 micron, about 65 micron, about 70 micron, about 75 micron, about 80 micron, about 85 micron, about 90 micron, about 95 micron, about 100 micron, or larger. In addition, the first filter membrane may have a pore size that falls within a range of two of the above values (i.e., a range of from about 1 micron to about 100 micron, a range of from about 25 micron to about 50 micron, etc.) as well as a value that is an integer that falls between any two of the above values.

In certain non-limiting embodiments, the second filter membrane is formed of a material such as (for example, but not by way of limitation) cellulose (such as, but not limited to, cellulose acetate and cellulose nitrate), glass fiber, nylon, polyester, polytetrafluoroethylene (PTFE), polyethersulfone (PES), silicon, any combinations thereof, and the like. In certain non-limiting embodiments, the second filter membrane has a pore size of less than about 5 micron, about 4 micron, about 3 micron, about 2 micron, about 1 micron, about 0.9 micron, about 0.8 micron, about 0.7 micron, about 0.6 micron, about 0.5 micron, about 0.45 micron, about 0.4 micron, about 0.3 micron, about 0.2 micron, about 0.1 micron, or lower. In addition, the second filter membrane may have a pore size that falls within a range of two of the above values (i.e., a range of from about 0.1 micron to about 2 micron, a range of from about 0.5 micron to about 1 micron, etc.) as well as a value that is an integer that falls between any two of the above values.

The acoustophoresis step may be performed under any conditions that will result in lysis of substantially all blood cells that remain after the prefiltration step (i.e., passing the sample through the first filter membrane). For example (but not by way of limitation), international patent application Publication No. WO 2021/222084, entitled “Acoustophoretic Lysis Devices and Methods,” published Apr. 11, 2021 (and expressly incorporated herein by reference) discloses an exemplary lysis device and various conditions for performing the acoustophoresis step in accordance with the present disclosure.

A non-limiting example of a lysis device for performing the acoustophoresis step that can be utilized in accordance with the present disclosure includes a lysis device configured to lyse red blood cells in an acoustophoresis compartment by means of ultrasonic acoustic waves, shear forces, pressure, and/or fluid movement, generated in the acoustophoresis compartment by an acoustic transducer connected to the acoustophoresis compartment and driven at one or more particular excitation frequency, or range of excitation frequencies. The sample (i.e., the pre-filtered mixture) may flow through the acoustophoresis compartment or through a microchannel within the confines of the outer surface of the acoustophoresis compartment, and an acoustic transducer is attached (e.g., bonded) to (a portion of) the outer surface of the acoustophoresis compartment. The acoustic transducer may be a piezoelectric ultrasonic transducer, and may be configured to generate ultrasonic activity, producing sound waves with resonant frequencies, by expanding and contracting when electrical frequency and voltage is applied. The acoustic transducer is configured to generate ultrasonic acoustic standing waves inside the sample (e.g., inside the pre-filtered mixture) in the acoustophoresis compartment and/or in the microchannel thereof, and is configured to vibrate the acoustophoresis compartment/microchannel such that shear forces are induced within the acoustophoresis compartment (or microchannel), and where the acoustic standing waves and the shear forces cause cavitation in the sample (e.g., in the pre-filtered mixture) thereby rupturing cell walls of the red blood cells present in the sample (e.g., present in the pre-filtered mixture).

Non-limiting examples of conditions for performing the acoustophoresis step that can be utilized in accordance with the present disclosure include the emission of ultrasonic acoustic waves at one or more frequencies in a range of from about 300 kHz to about 370 kHz, such as about 320 kHz to about 350 kHz. The acoustic transducer may be configured to produce ultrasonic sound waves (which may also be referred to herein as ultrasonic acoustic waves) having a resonant frequency that causes resonances and/or cavitation in the sample in the acoustophoresis compartment (or microchannel) such that walls of red blood cells in the sample (e.g., in the pre-filtered mixture) are ruptured. The resonant frequency, and/or the frequency range, may be determined based on one or more factors including the size, shape, and material of acoustophoresis compartment; the size and shape of the microchannel of the acoustophoresis compartment; the amount of fluid in the sample; and/or the size, shape, and material of the acoustic transducer. The following formula may be used to determine, at least in part, an acoustic node inside the acoustophoresis compartment/microchannel (with an exemplary 2000 μm width and 100 μm depth), without considering any minor reflection or other mirroring:

$$f = v / λ$$

where f is the frequency, v the wave speed in fluid and λ the wavelength (where the wavelength is two times the width of the compartment or the microchannel, for a half-wavelength resonance mode with a single node over the width of the compartment/channel).

Because the resonant frequency of the acoustophoresis compartment may be difficult to calculate precisely, in one embodiment, the acoustic transducer may be configured to sweep the frequency range between approximately 300 kHz and approximately 370 kHz, such as, in approximately one kHz steps.

In addition, the acoustophoresis step may be performed for any period of time that results in lysis of substantially all blood cells present in the pre-filtered mixture. Non-limiting examples of time periods that may be utilized in accordance with the present disclosure include about 1 second, about 2 seconds, about 3 seconds, about 4 seconds, about 5 seconds, about 6 seconds, about 7 seconds, about 8 seconds, about 9 seconds, about 10 seconds, about 11 seconds, about 12 seconds, about 13 seconds, about 14 seconds, about 15 seconds, about 16 seconds, about 17 seconds, about 18 seconds, about 19 seconds, about 20 seconds, about 25 seconds, about 30 seconds, about 35 seconds, about 40 seconds, about 45 seconds, about 50 seconds, about 55 seconds, about 60 seconds, about 65 seconds, about 70 seconds, about 75 seconds, about 80 seconds, about 85 seconds, about 90 seconds, about 95 seconds, about 100 seconds, about 110 seconds, about 120 seconds, about 130 seconds, about 140 seconds, about 150 seconds, about 160 seconds, about 170 seconds, about 180 seconds, about 3.5 minutes, about 4 minutes, about 4.5 minutes, about 5 minutes, or longer. In addition, the acoustophoresis step may be performed for a time period that falls within a range of two of the above values (i.e., a range of from about 1 second to about 5 minutes, a range of from about 10 seconds to about 3 minutes, a range of from about 15 seconds to about 60 seconds, etc.) as well as a value that is an integer that falls between any two of the above values. In a particular (but non-limiting) embodiment, the acoustophoresis step is performed for a time period of equal to or less than about 60 seconds.

The term “lysis of substantially all blood cells” refers to a level of blood cell lysis that enables the ease of filtering of non-microorganism substances through the second filter so that substantially no blood cells will be retained on the surface of the second filter membrane and interfere with any diagnostic assays performed thereon. Non-limiting examples of a substantial level of lysis include lysis of at least about 80% of all blood cells present, at least about 85% of all blood cells present, at least about 90% of all blood cells present, at least about 91% of all blood cells present, at least about 92% of all blood cells present, at least about 93% of all blood cells present, at least about 94% of all blood cells present, at least about 95% of all blood cells present, at least about 96% of all blood cells present, at least about 97% of all blood cells present, at least about 98% of all blood cells present, at least about 99% of all blood cells present in the pre-filtered mixture, and about 100% of all blood cells present in the pre-filtered mixture.

In addition, all of the steps of the method (i.e., diluting, pre-filtering, acoustophoresis, and filtering steps) may be completed within any period of time that results in the desired isolation of at least one microorganism present in the biological sample (as well as performance of the respective diagnostic assay, if present). Non-limiting examples of time periods that may be utilized in accordance with the present disclosure include about 10 minutes, about 15 minutes, about 20 minutes, about 30 minutes, about 40 minutes, about 50 minutes, about 60 minutes, about 70 minutes, about 80 minutes, about 90 minutes, about 100 minutes, about 110 minutes, about 120 minutes, about 130 minutes, about 140 minutes, about 150 minutes, about 160 minutes, about 170 minutes, about 180 minutes, about 3.5 hours, about 4 hours, about 4.5 hours, about 5 hours, or longer. In addition, the method can be completed within a time period that falls within a range of two of the above values (i.e., a range of from about 1 hour to about 4 hours, a range of from about 1.5 hours to about 2.5 hours, etc.) as well as a value that is an integer that falls between any two of the above values. In a particular (but non-limiting) example, the method is completed within a time period of about 2 hours or less.

The individual filtration steps of the method may each be allowed to occur solely via gravimetric flow; alternatively, one or both of the filtration steps may be assisted via application of a pump or a vacuum thereto. For example, a peristaltic pump may be utilized to pump the mixture through the filter membrane(s) in the pre-filtration and/or filtration steps. Alternatively (and/or in addition thereto), a vacuum pump may be utilized to assist in filtering the mixture through the filter membrane(s) in the pre-filtration and/or filtration steps.

The steps of the methods of the present disclosure may be performed in a batch or continuous manner.

Certain non-limiting embodiments of the present disclosure are directed to microfluidic devices designed for performing any of the methods described or otherwise contemplated herein. The microfluidic devices include the first and second filter membranes described herein above in combination with an acoustophoresis compartment that is in fluidic communication with a lower surface of the first filter membrane and an upper surface of the second filter membrane. The acoustophoresis compartment is designed to allow a mixture present therein to be exposed to acoustophoresis sufficient to substantially lyse blood cells present in the mixture.

The microfluidic device may further include a sample application chamber in which a biological sample may be applied; the sample application chamber may either include or be capable of being in fluidic communication with an upper surface of the first filter membrane. If the first filter membrane is not present in the sample application chamber, then the microfluidic device may further include an inlet channel in fluidic communication therewith that is also in fluidic communication with another compartment that contains at least the upper surface of the first filter membrane. The device may further be provided with one or more additional compartments (in any arrangement or distribution) that allows the device to function in accordance with the present disclosure. For example, the device may further be provided with one or more additional compartments in which the diagnostic assay is performed. In addition, the device may be provided with a waste compartment that is in fluidic communication with the lower surface of the second filter membrane for collecting everything that filters through the first and second filter membranes.

The microfluidic device may further contain any regents required to perform the methods of the present disclosure. For example (but not by way of limitation), the microfluidic device may contain a predetermined volume of dilution buffer disposed in the sample application chamber (or another compartment that is capable of being in fluidic communication with a compartment that contains at least the upper surface of the first filter membrane) for diluting the biological sample prior to the pre-filtering step. In addition, in certain non-limiting embodiments, the microfluidic device may include one or more reagents for performing the diagnostic assay(s) and/or one or more reagents for resuspension of microorganisms isolated on the second filter membrane prior to performing the diagnostic assay(s). Further, the microfluidic device can further include additional reagents, such as but not limited to, wash solutions, dilution solutions, excipients, interference solutions, positive controls, negative controls, quality controls, and the like.

Any of the compartments of the microfluidic device may be sealed to maintain reagent(s) disposed therein in a substantially air tight environment until use thereof. In this manner, two or more compartments of the microfluidic device are capable of being in fluidic communication with one another.

The term “capable of being in fluidic communication” as used herein indicates that samples/reagents may freely flow between two compartments, as well as that one of the compartment(s) may be sealed, but that the two compartments are capable of having fluid flow therebetween upon puncture of a seal formed therein or therebetween.

The microfluidic devices of the present disclosure may be provided with any other desired features known in the art or otherwise contemplated herein. For example, but not by way of limitation, the microfluidic devices of the present disclosure may further include a read chamber.

Certain non-limiting embodiments of the present disclosure are directed to a system for performing any of the methods disclosed or otherwise contemplated herein. The system includes any of the microfluidic devices disclosed or otherwise contemplated herein, in combination with one or more components. For example (but not by way of limitation), the system may further include at least one biological sample collection device, a peristaltic pump, a vacuum pump, an instrument for performing the isolation steps, an analyzer for performing the diagnostic assay, and/or an instrument/analyzer for performing both the isolation method and the diagnostic assay.

Certain non-limiting embodiments of the present disclosure are directed to a kit containing any of the microfluidic devices disclosed or otherwise contemplated herein. In addition, the kit may further contain one or more other component(s) or reagent(s) for performing biological sample collection(s), microorganism isolation(s), and/or diagnostic application(s) in accordance with the present disclosure. The nature of these additional component(s)/reagent(s) will depend upon various factors such as (but not limited to) the type of biological sample and the diagnostic assay format, and identification thereof is well within the skill of one of ordinary skill in the art; therefore, no further description thereof is deemed necessary.

In certain non-limiting embodiments, the kits of the present disclosure include any of the microfluidic devices described or otherwise contemplated herein, either alone or in combination with one or more of biological sample collection device(s), aqueous reagent(s) in which any microorganism isolated on the second filter membrane can be suspended for conducting one or more diagnostic assays, diagnostic assay reagent(s), peristaltic pump(s), vacuum pump(s), and the like.

Also, the various components/reagents present in the kit may each be in separate containers/compartments, or various components/reagents can be combined in one or more containers/compartments, depending on the cross-reactivity and stability of the components/reagents. In addition, the kit may include a set of written instructions explaining how to use the kit. A kit of this nature can be used in any of the methods described or otherwise contemplated herein.

The following is a list of non-limiting illustrative embodiments disclosed herein:
1. A method of isolating microorganisms present in a biological sample for diagnostic analysis, the method comprising:
(1) diluting the biological sample in a buffer to provide a mixture;
(2) pre-filtering the mixture to remove debris by passing the mixture through a first filter membrane, thereby providing a pre-filtered mixture;
(3) exposing the pre-filtered mixture to acoustophoresis at a frequency sufficient to substantially lyse blood cells present in the mixture; and
(4) filtering the acoustophoresis-treated mixture to remove debris resulting from the blood cell lysis by passing the acoustophoresis-treated mixture through a second filter membrane, whereby any microorganisms present in the biological sample are isolated on the second filter membrane.
2. The method of illustrative embodiment 1, wherein the biological sample is diluted in a range of from about 10-fold to about 1,000-fold.
3. The method of any one of the preceding illustrative embodiments, wherein the dilution buffer is selected from the group consisting of sodium chloride-containing, isotonic buffer; phosphate buffered saline; Bis-Tris, Bis-Tris propane, ADA (N-(2-Acetamido)iminodiacetic acid), PIPES (Piperazine-N,N′-bis(2-ethanesulfonic acid), ACES (N-2-aminoethanesulfonic acid), MOPS (3-morpholinopropanesulfonic acid), MOPSO (3-Morpholino-2-hydroxypropanesulfonic acid), BES (N,N-bis[2-hydroxyethyl]-2-aminoethanesulfonic acid), TES (2-[[1,3-dihydroxy-2-(hydroxymethyl) propan-2-yl]amino]ethanesulfonic acid), HEPES (4-(2-hydroxyethyl)-1-piperazineethanesulfonic acid), DIPSO (3-(N,N-Bis[2-hydroxyethyl]amino)-2-hydroxypropanesulfonic acid, N,N-Bis(2-hydroxyethyl)-3-amino-2-hydroxypropanesulfonic acid) buffers, and combinations thereof.
4. The method of any one of the preceding illustrative embodiments, wherein the first filter membrane has a larger pore size than the second filter membrane.
5. The method of any one of the preceding illustrative embodiments, wherein the first filter membrane has a pore size in a range of from about 25 micron to about 50 micron.
6. The method of any one of the preceding illustrative embodiments, wherein the second filter membrane has a pore size that is smaller than at least one of a length and a width of a bacterial cell.
7. The method of any one of the preceding illustrative embodiments, wherein the second filter membrane has a pore size in a range of from about 0.5 micron to about 1 micron.
8. The method of any one of the preceding illustrative embodiments, wherein step (3) includes emission of ultrasonic acoustic waves at one or more frequencies in a range of from about 320 kHz to about 350 kHz.
9. The method of any one of the preceding illustrative embodiments, wherein step (3) is performed over a period equal to or less than about 60 seconds.
10. The method of any one of the preceding illustrative embodiments, wherein step (3) is performed for a period of about 30 seconds.
11. The method of any one of the preceding illustrative embodiments, wherein steps (1) through (4) are completed in a time period in a range of from about 1.5 hours to about 2.5 hours.
12. The method of any one of the preceding illustrative embodiments, wherein steps (1) through (4) are completed in a time period of about 2 hours or less.
13. The method of any one of the preceding illustrative embodiments, wherein a peristaltic pump is utilized to pump the mixture through the filter membrane(s) in at least one of steps (2) and (4).
14. The method of any one of the preceding illustrative embodiments, wherein a vacuum pump is utilized to assist in filtering the mixture through the filter membrane(s) in at least one of steps (2) and (4).
15. The method of any one of the preceding illustrative embodiments, further comprising the step of performing, after step (4), at least one diagnostic assay on the second filter membrane to identify a genus of microorganism present on the second filter membrane.
16. The method of any one of the preceding illustrative embodiments, wherein the diagnostic assay is a sepsis assay.
17. The method of any one of the preceding illustrative embodiments, further comprising the steps of:
(5) incubating an upper surface of the second filter membrane with an aqueous reagent such that any microorganism isolated on the second filter membrane is suspended in the aqueous reagent; and
(6) performing at least one diagnostic assay on the aqueous reagent to identify a genus of microorganism suspended therein.
18. The method of any one of the preceding illustrative embodiments, wherein the diagnostic assay is a sepsis assay.
19. A kit, comprising:
a microfluidic device capable of performing the method of any one of any one of the preceding illustrative embodiments 1-18, wherein the microfluidic device comprises:
   the first filter membrane;
   the second filter membrane; and
   a compartment in fluidic communication with a lower surface of the first filter membrane and an upper surface of the second filter membrane, wherein the compartment is designed to allow a mixture present therein to be exposed to acoustophoresis sufficient to substantially lyse blood cells present in the mixture.
20. The kit of any one of the preceding illustrative embodiments, further comprising at least one of:
at least one biological sample collection device;
an aqueous reagent in which any microorganism isolated on the second filter membrane can be suspended for conducting a diagnostic assay;
at least one diagnostic assay reagent;
a peristaltic pump; and
a vacuum pump.

Thus, in accordance with the present disclosure, there have been provided methods, devices, systems, and kits which fully satisfy the objectives and advantages set forth hereinabove. Although the present disclosure has been described in conjunction with the specific drawings, experimentation, results, and language set forth hereinabove, it is evident that many alternatives, modifications, and variations will be apparent to those skilled in the art. Accordingly, it is intended to embrace all such alternatives, modifications, and variations that fall within the spirit and broad scope of the present disclosure.

What is claimed is:

1. A method of isolating microorganisms present in a biological sample for diagnostic analysis, the method comprising:
(1) diluting the biological sample in a buffer to provide a mixture;
(2) pre-filtering the mixture to remove debris by passing the mixture through a first filter membrane, thereby providing a pre-filtered mixture;
(3) exposing the pre-filtered mixture to acoustophoresis at a frequency sufficient to substantially lyse blood cells present in the mixture; and
(4) filtering the acoustophoresis-treated mixture to remove debris resulting from the blood cell lysis by passing the acoustophoresis-treated mixture through a second filter membrane, whereby any microorganisms present in the biological sample are isolated on the second filter membrane.

2. The method of claim 1, wherein the biological sample is diluted in a range of from about 10-fold to about 1,000-fold.

3. The method of claim 1, wherein the dilution buffer is selected from the group consisting of sodium chloride-containing, isotonic buffer; phosphate buffered saline; Bis-Tris, Bis-Tris propane, ADA (N-(2-Acetamido)iminodiacetic acid), PIPES (Piperazine-N,N′-bis(2-ethanesulfonic acid), ACES (N-2-aminoethanesulfonic acid), MOPS (3-morpholinopropanesulfonic acid), MOPSO (3-Morpholino-2-hydroxypropanesulfonic acid), BES (N,N-bis[2-hydroxyethyl]-2-aminoethanesulfonic acid), TES (2-[[1,3-dihydroxy-2-(hydroxymethyl) propan-2-yl]amino]ethanesulfonic acid), HEPES (4-(2-hydroxyethyl)-1-piperazineethanesulfonic acid), DIPSO (3-(N,N-Bis[2-hydroxyethyl]amino)-2-hydroxypropanesulfonic acid, N,N-Bis(2-hydroxyethyl)-3-amino-2-hydroxypropanesulfonic acid) buffers, and combinations thereof.

4. The method of claim 1, wherein the first filter membrane has a larger pore size than the second filter membrane.

5. The method of claim 1, wherein the first filter membrane has a pore size in a range of from about 25 micron to about 50 micron.

6. The method of claim 1, wherein the second filter membrane has a pore size that is smaller than at least one of a length and a width of a bacterial cell.

7. The method of claim 6, wherein the second filter membrane has a pore size in a range of from about 0.5 micron to about 1 micron.

8. The method of claim 1, wherein step (3) includes emission of ultrasonic acoustic waves at one or more frequencies in a range of from about 320 kHz to about 350 kHz.

9. The method of claim 1, wherein step (3) is performed over a period equal to or less than about 60 seconds.

10. The method of claim 9, wherein step (3) is performed for a period of about 30 seconds.

11. The method of claim 1, wherein steps (1) through (4) are completed in a time period in a range of from about 1.5 hours to about 2.5 hours.

12. The method of claim 1, wherein steps (1) through (4) are completed in a time period of about 2 hours or less.

13. The method of claim 1, wherein a peristaltic pump is utilized to pump the mixture through the filter membrane(s) in at least one of steps (2) and (4).

14. The method of claim 1, wherein a vacuum pump is utilized to assist in filtering the mixture through the filter membrane(s) in at least one of steps (2) and (4).

15. The method of claim 1, further comprising the step of performing, after step (4), at least one diagnostic assay on the second filter membrane to identify a genus of microorganism present on the second filter membrane.

16. The method of claim 15, wherein the diagnostic assay is a sepsis assay.

17. The method of claim 1, further comprising the steps of:
(5) incubating an upper surface of the second filter membrane with an aqueous reagent such that any microorganism isolated on the second filter membrane is suspended in the aqueous reagent; and
(6) performing at least one diagnostic assay on the aqueous reagent to identify a genus of microorganism suspended therein.

18. The method of claim 17, wherein the diagnostic assay is a sepsis assay.

19. A kit, comprising:
a microfluidic device capable of performing the method of any one of claims 1-18, wherein the microfluidic device comprises:
the first filter membrane;
the second filter membrane; and
a compartment in fluidic communication with a lower surface of the first filter membrane and an upper surface of the second filter membrane, wherein the compartment is designed to allow a mixture present therein to be exposed to acoustophoresis sufficient to substantially lyse blood cells present in the mixture.

20. The kit of claim 19, further comprising at least one of:
at least one biological sample collection device;
an aqueous reagent in which any microorganism isolated on the second filter membrane can be suspended for conducting a diagnostic assay;
at least one diagnostic assay reagent;
a peristaltic pump; and
a vacuum pump.
